(19) United States
(12) Patent Application Publication
(10) Pub. No.: US 2014/0380455 A1
(43) Pub. Date: Dec. 25, 2014

(54) System and Method for Making Application Requests into Private Firewalled Networks

(71) Applicant: TimeTrade Systems, Inc., Tewksbury, MA (US)

(72) Inventors: Brian Kelly, Tewksbury, MA (US); Kevin Esler, Tewksbury, MA (US)

(73) Assignee: TimeTrade Systems, Inc., Tewksbury, MA (US)

(21) Appl. No.: 14/098,607

(22) Filed: Dec. 6, 2013

Related U.S. Application Data
(60) Provisional application No. 61/837,675, filed on Jun. 21, 2013.

(51) Int. Cl. H04L 29/06

(52) U.S. Cl. CPC H04L 63/029
USPC 726/11

(57) ABSTRACT

A first agent process is provided in a first computing environment. The first agent process is in communication with a first application. A second agent process is provided in a second computing environment, and the second agent process is in communication with a second application. Both the second agent process and first application run behind a firewall. The first agent process and second agent process communicate with each other across the firewall to have tasks performed by the second application on behalf of the first application.

### CROSS-REFERENCE TO RELATED APPLICATION

This application claims priority under to U.S. Provisional Patent Application Ser. No. 61/837,675, filed Jun. 21, 2013, and entitled “A System for Making Network Requests into Private Firewalled Networks,” the entire contents of which are hereby incorporated by reference.

### TECHNICAL FIELD

The present disclosure relates to computer networking and firewall technology.

### BACKGROUND

A primary purpose of a firewall is to disallow “outside-in” connection establishment to prevent attackers from gaining access to internal systems of an organization's network. However there are occasions when organizations protected by firewalls wish to permit another external organization or system to send requests through a firewall. Typically, this is done through a reconfiguration of the firewall rules to grant that external organization special access, either through the use of a particular dedicated Transmission Control Protocol (TCP) port or with special credentials. This approach is costly and risky, since it effectively means that the firewall's “purity” has been compromised, and an attacker could exploit that.

### SUMMARY

A system and method are presented herein which allows a participating organization to allow another organization to send network requests through a firewall without requiring any change to that firewall's configuration. Requests are allowed to flow through a firewall at the “logical” level by using the reverse approach at the “physical” transport level, taking advantage of the fact that firewalls almost always allow “outbound” connections from the protected organization out to the Internet. A dedicated “agent” process is first run within the protected organization with the consent of the protected organization. This internal agent then makes outbound requests to the organization wishing to send network requests into the protected organization, initiating an outbound TCP connection to do so. The internal agent sends requests to an external agent in a computing environment outside of the firewall, which external agent is in communication with an external application. The request sent to the external agent asks for “work items” or tasks to be perform by the internal application within the private network and the internal agent receives the work items as replies from the external agent. Once the work for an item is done, the work result is transmitted back, as a new request, to the external agent that is in communication with the external application. A reply will come back to the internal agent only when more work should be performed.

Using these techniques, an application outside of a private/secure computing environment can have access to functions performed by an application that is within the private/secure computing environment without having to change permissions on the firewall that protects the private computing environment.

### BRIEF DESCRIPTION OF THE DRAWINGS

FIG. 1 is diagram of a system illustrating conventional communications across a firewall.

FIG. 2 is a system diagram illustrating communications across a firewall according to the techniques presented herein.

FIG. 3 illustrates an example of a system architecture in which the techniques presented herein may be employed.

FIG. 4 is a diagram illustrating the layers in the Open Systems Interconnection (OSI) model in which communications are made between agent processes, and between each agent process and its associated application.

### DETAILED DESCRIPTION OF EXAMPLE EMBODIMENTS

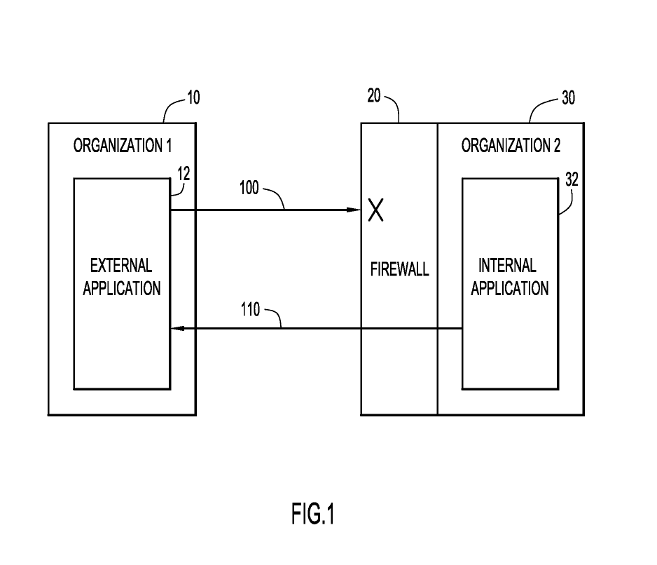

Reference is first made to FIG. 1. FIG. 1 illustrates an example of a problem for which the present invention solves. In this scenario, there is first organization 10, called Organization 1, that is separate from and outside of a firewall 20 of organization 30, called Organization 2. There is an External Application 12 running within Organization 1 and an Internal Application 32 running within Organization 2. Organization 2 may also be referred to as a private network and Organization 1 referred to as an outside or external network. External Application 12 wishes to send requests to Internal Application 32 (running within Organization 2), but it cannot due to the firewall 20 in use at Organization 2.

Specifically, External Application 12, at 100, sends a request to Internal Application 32. The request 100 hits the firewall 20 before being allowed to pass to the Internal Application 32. The firewall 20 drops the request 100 if the request from the External Application 12 is not on an “allow” list of the firewall 20. However, Internal Application 32 can send an outbound request through the firewall 20 because the firewall 20 generally does not stop outbound communications.

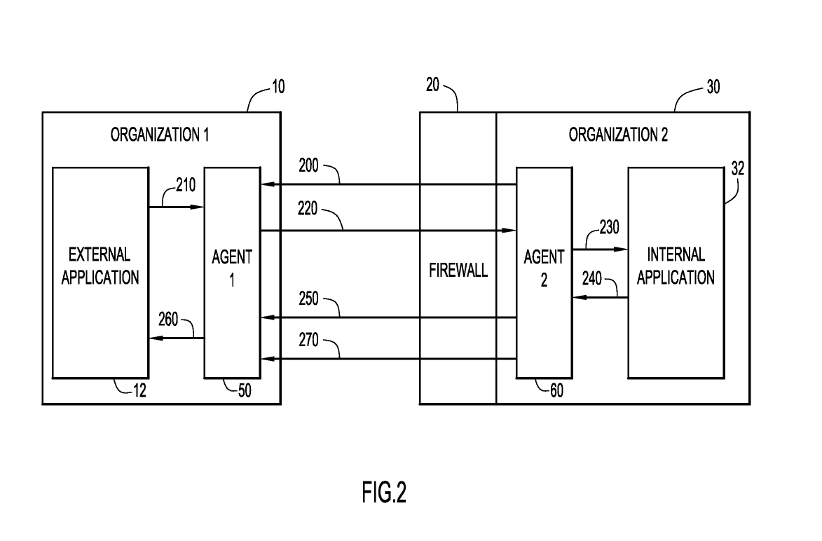

Reference is now made to FIG. 2. FIG. 2 shows a configuration by which the External Application 12 can communicate with the Internal Application 32. To this end, a first (internal) agent process 50, called Agent 1, is provided in the first organization 10 and a second (external) agent process 60, called Agent 2, is provided in the second organization 30. The first and second agent processes 50 and 60 may be in the form of software programs that are executed by one or more processors in the computing environments of the respective organizations 10 and 30, respectively. Requests are allowed to flow outbound through firewall 20 at the “logical” level by using the reverse approach at the “physical” transport level, taking advantage of the fact that firewalls almost always allow “outbound” connections from the protected organization.

Agent 2 is a dedicated “agent” process that runs within the protected organization, Organization 2 in this example, with the consent of the protected organization. Agent 2 makes outbound requests (through firewall 20) to the organization (Organization 1) wishing to send network requests into the protected organization (Organization 2), initiating an outbound connection to do so. Agent 2 sends requests to ask for “work items” or “tasks” to perform within the protected organization (Organization 2) and receives the work items as replies from Organization 1. Once the work for an item or task is done, the work or task result is transmitted back to the outside organization as a new request. A reply will come back to Agent 2 only when more work should be performed.

A more specific description of the flow shown in FIG. 2 is now described. At 200, Agent 2, the agent process running behind the firewall (F/W) 20 within a computing environment of the protected organization 30, sends an outbound agent request across the firewall 20 to Agent 1, the agent process running outside of the computing environment of the protected organization, i.e., in organization 10. The outbound agent request is configured to ask for one or more application tasks to be performed by Internal Application 32 within the computing environment of the protected organization.

Agent 1 receives the outbound agent request from Agent 2, and waits for an application request from the External Application 12. The application request specifies one or more application tasks to be performed by the Internal Application 32. At 210, Agent 1 receives an application request from the External Application 12, and in response, generates an inbound agent reply.

At 220, Agent 1 sends the inbound agent reply across the firewall 20 to Agent 2 in the protected organization 30. Agent 2 receives the inbound agent reply, and at 230, recreates the one or more application tasks contained in the inbound agent reply, and re-issues the one or more application tasks to the Internal Application 32. The Internal Application 32 operates on the one or more application tasks and generates application task results that are returned to Agent 2 at 240. Agent 2 receives the application task results.

At 250, Agent 2 generates a new outbound agent request containing the application task results generated by the Internal Application 32, and sends the new outbound agent request across the firewall 20 to Agent 1. The new outbound agent request contains the application task results together with an agent request for additional one or more application tasks.

At 260, Agent 1 receives the new outbound agent request and presents the application task results (contained in the new outbound agent request) to the External Application 12 in an application reply that is correlated to the application request received by Agent 1 from the External Application at 210.

At 270, Agent 2 generates and sends another outbound agent request configured to ask for one or more application tasks to be performed by Internal Application 32. Agent 1 generates and sends a new inbound agent reply to Agent 2 when a new application request for one or more application tasks is received from the External Application 12. The process repeats until External Application 12 has no further application tasks to send to the External Application 32.

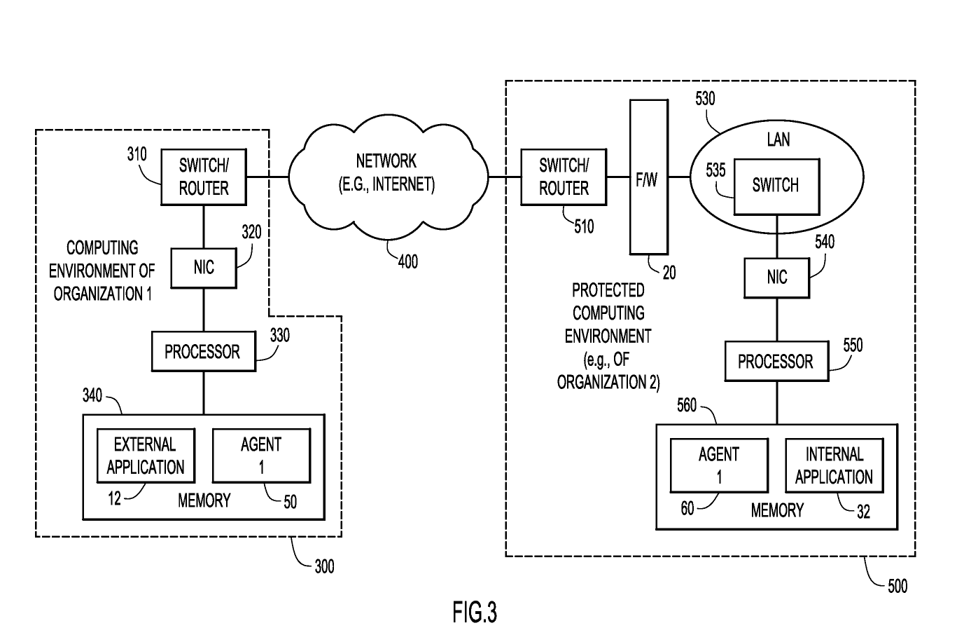

Reference is now made to FIG. 3. FIG. 3 shows a more detailed block diagram of the system components with which the techniques presented herein may be used. In FIG. 3, a computing environment 300 is shown for the external organization, Organization 1. The computing environment 300 includes one or more network switches or routers, shown collectively at 310, at least one network interface card/unit (NIC) 320, a processor 330, and memory 340. The memory 340 stores software instructions for the External Application 12 and for Agent 1 at reference numeral 50. There may be additional elements in the computing environment 300, but for simplicity, they are not shown in FIG. 3. It should also be understood that there may be user interface equipment, such as touch-screen displays, computer mice, keyboards, etc., to enable user interactions in the computing network 300. The processor 330 may be one or more instances of a microprocessor or microcontroller. The processor 330 is configured to perform various operations, including the operations described above in connection with FIG. 2, by executing the software instructions for the agent process 50 (Agent 1) and for the External Application 12.

As shown in FIG. 3, the computing environment 300 is connected to a network 400, e.g., a wide area network (the Internet) or local area network, in order to enable communication with a computing environment 500 for the protected organization, e.g., Organization 2. The computing environment 500 includes a switch or router 510, firewall 20 or other network security appliance with firewall functionality, a local area network (LAN) 530 including one or more switches 535, a NIC 540, a processor 550 and memory 560. The memory 560 stores software instructions for agent process 60 (Agent 2) and for Internal Application 32. It should be understood that the functions of firewall 20 may be performed by software stored in memory 560 and executed by processor 550, or by some other processor in the computing environment 500. The processor 550 executes the software instructions stored in memory 560 for Agent 2 and the Internal Application 32 to perform the functions described above in connection with FIG. 2.

The memories 340 and 560 may comprise read only memory (ROM), random access memory (RAM), magnetic disk storage media devices, optical storage media devices, flash memory devices, electrical, optical, or other physical/tangible memory storage devices. Thus, in general, the memories 340 and 560 may comprise one or more tangible (non-transitory) computer readable storage media (e.g., a memory device) encoded with software comprising computer executable instructions and when the software is executed (by an associated processor) it is operable to perform the operations described herein.

The computing environments 300 and 500 may be considered as different computing systems or (enterprise) networks. While the techniques presented herein are described with respect to physical computing environments, such as that shown in FIG. 3, this is not meant to be limiting. For example, these techniques may be applicable to data center/cloud computing environments where the Internal and External Applications 12 and 32 are virtual machines running on a computing node, and the firewall 20 is a physical or virtualized process (running on a computing node). The agent processes 50 and 60 may also be embodied as virtual machines running on the same or different computing nodes. The computing environments 300 and 500 may be embodied by different tenants of a data center/cloud computing system. Thus, to generalize, the computing environments may be physical or virtualized computing environments, and the techniques presented herein are applicable to either a physical or virtual computing environment instantiation.

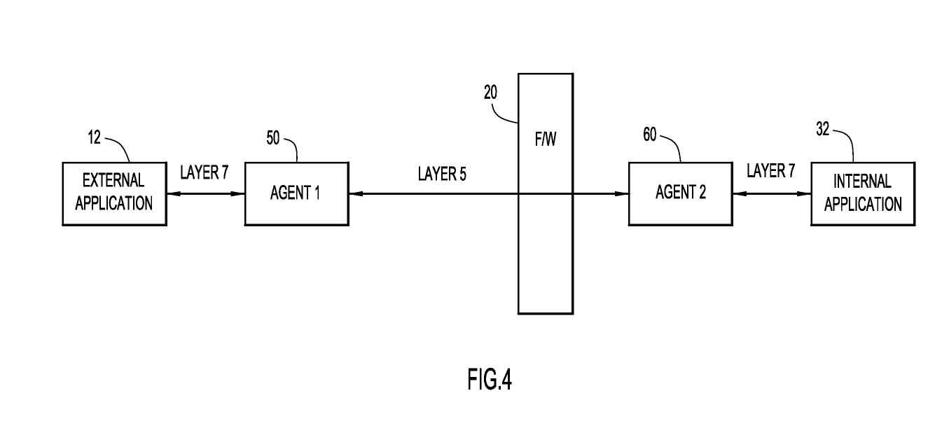

Reference is now made to FIG. 4. FIG. 4 shows in more detail the communications between the agent processes 50 and 60, and also between the agent processes and their associated application. More specifically, the first agent process 50 and second agent process 60 are configured to send agent requests and agent replies to each other using Layer 5 (session layer) communications of the Open Systems Interconnection (OSI) model. The first agent process communicates with the external application 12 using Layer 7 communications and similarly the second agent process communicates with the internal application 32 using Layer 7 communications. For example, the agent-to-agent communications are made by way of Transmission Control Protocol (TCP) exchanges.

The following is one example of the application of the architecture described herein. Reference is made to FIGS. 2 and 3. Also, for purposes of this description, the first agent process (Agent 1) is referred to as the “external agent” and the second agent process (Agent 2) is referred to as the “internal” agent.

Step 1. The internal agent starts up and immediately issues a “give me work to do” request to the external agent.

Step 2. The External Application issues a request intended for the Internal Application. The request is to add customer “A” to an internal database that the Internal Application manages within the computing environment of the protected organization. The External Application will now wait for a reply to its database update request.

Step 3. The external agent receives the customer addition request and knows that it is destined for the Internal Application.

Step 4. Since Step 1 has already occurred, the external agent is able to immediately send the application request to the internal agent by virtue of replying to the “give me work” request already sitting idle in Step 1. To assist in subsequent request/reply correlation, the external agent appends a request identifier value of, for example, “123” to the reply.

Step 5. The internal agent receives the reply to the “give me work” request it made in Step 1 and parses the application command contained within it, checking for integrity and security parameters if also configured to do so.

Step 6. The internal agent reissues the same application request as was made in Step 2, this time to the Internal Application.

Step 7. The Internal Application adds customer “A” to its database, and returns a “success” status code to the internal agent that made the request.

Step 8. The internal agent reissues another “give me work to do” request to the external agent, but as part of the same request it also sends the successful status code result of the Internal Application's database addition, as well as the reply identifier code “123”.

Step 9. The external agent parses the new “give me work to do” request. It first looks for the result to its outstanding application requests, and it finds the results to request with identifier 123 which was issued in Step 2.

Step 10. The external agent now returns the success status code of the database addition to the External Application. The full round-trip of application-to-application calls has now been made.

Step 11. The external agent now re-enters the state it was in in Step 1, waiting for new application requests from the External Application, and the process repeats from Step 1.

The following is another example of an application of the architecture described herein. Reference is made to FIGS. 2 and 3. Again, for purposes of this description, the first agent process (Agent 1) is referred to as the “external agent” and the second agent process (Agent 2) is referred to as the “internal” agent.

Step 1. The internal agent starts up and immediately issues a “give me work to do” request to the external agent.

Step 2. The External Application is in this example an appointment scheduling application hosted by a server in the Internet. The appointment scheduling application attempts to automatically coordinate meeting times for people in different organizations. The External Application issues a request intended for the Internal Application, which in this example is a private employee-only calendaring and scheduling system. The request issued by the External Application is to query for available times on the private calendar for the user “John Doe” for the upcoming week. The External Application will now wait for a reply to its availability request.

Step 3. The external agent receives the availability query request and knows that it is destined for the Internal Application.

Step 4. Since Step 1 has already occurred, the external agent is able to immediately send the application request, across the firewall, to the internal agent by virtue of replying to the “give me work” request already sitting idle in Step 1. To assist in subsequent request/reply correlation, the external agent appends a request identifier value of, for example, “456” to the reply.

Step 5. The internal agent receives the reply to the “give me work to do” request it made in Step 1 and parses the application command contained within it, checking for integrity and security parameters if also configured to do so.

Step 6. The internal agent reissues the same application request as was made in Step 2, this time to the Internal Application.

Step 7. The Internal Application queries for available times for user “John Doe” for the upcoming week, and returns the availability data result to the internal agent that made the request.

Step 8. The internal agent reissues another “give me work to do” request (outbound through the firewall) to the external agent, but as part of the same request it also sends the availability data, as well as the reply identifier code “456”.

Step 9. The external agent parses the new “give me work to do” request. It first looks for the result to any of its outstanding application requests, and it discovers the results to request with identifier “456” which was issued in Step 2.

Step 10. The external agent now returns the calendar availability data of “John Doe” to the External Application. The full round-trip of application-to-application calls has now been made, and the External Application can now successfully coordinate meeting times for its users.

Step 11. The external agent now re-enters the state it was in in Step 1, waiting for new application requests from the External Application, and the process repeats from Step 1.

To summarize, a method is provided involving first and second agent processes, where the second agent process runs behind a firewall within a computing environment and the first agent process runs outside the firewall. The second agent process sends an outbound agent request across the firewall to a first agent process outside of the computing environment. The outbound agent request is configured to ask for one or more application tasks to be performed by an internal application running behind the firewall within the computing environment. An inbound agent reply is received at the second agent process from the first agent process. The inbound agent reply specifies one or more application tasks to be performed by the internal application within the computing environment on behalf of an external application outside the computing environment. The second agent process sends across the firewall to the first agent process a new outbound agent request containing application task results generated by the internal application.

Similarly, a system is provided comprising a first computing environment including a first agent process in communication with a first application, and a second computing environment including a second agent process in communication with a second application. Both the second agent process and second application run behind a firewall. The second agent process is configured to send an outbound agent request across the firewall to the first agent process, the outbound agent request configured to ask for one or more application tasks to be performed by the second application; receive an inbound agent reply from the first agent process sent in response to the outbound agent request, the inbound agent reply specifying one or more application tasks to be performed by the second application on behalf of the first application; recreate the one or more application tasks contained in the inbound agent reply; and re-issue the one or more application tasks to the second application.

Furthermore, an apparatus is provided comprising a network interface device configured to enable communications over a network; and a processor coupled to the network interface device. The processor is configured to: generate and send an outbound agent request across a firewall from a second agent process running behind the firewall in a computing environment to a first agent process outside of the computing environment, the outbound agent request asking for one or more application tasks to be performed by an internal application running behind the firewall within the computing environment; receive an inbound agent reply from the first agent process sent in response to the outbound agent request, the inbound agent reply specifying one or more application tasks to be performed by the internal application on behalf of an external application; and recreate the one or more application tasks contained in the inbound agent reply, and re-issue the one or more application tasks to the internal application.

Further still, one or more computer readable storage media are provided encoded with software comprising computer executable instructions and when the software is executed operable to: generate and send an outbound agent request across a firewall from a second agent process running behind the firewall in a computing environment to a first agent process outside of the computing environment, the outbound agent request asking for one or more application tasks to be performed by an internal application running behind the firewall within the computing environment; receive an inbound agent reply from the first agent process sent in response to the outbound agent request, the inbound agent reply specifying one or more application tasks to be performed by the internal application on behalf of an external application; recreate the one or more application tasks contained in the inbound agent reply; and re-issue the one or more application tasks to the internal application.

The above description is intended by way of example only. Various modifications and structural changes may be made therein without departing from the scope of the concepts described herein and within the scope and range of equivalents of the claims.

What is claimed is:

1. A method comprising:
at a second agent process running behind a firewall within a computing environment, sending an outbound agent request across the firewall to a first agent process outside of the computing environment, the outbound agent request asking for one or more application tasks to be performed by an internal application within the computing environment;
receiving an inbound agent reply at the second agent process from the first agent process, the inbound agent reply specifying one or more application tasks to be performed by the internal application within the computing environment on behalf of an external application outside the computing environment; and
sending from the second agent process across the firewall to the first agent process a new outbound agent request containing application task results generated by the internal application.

2. The method of claim 1, wherein sending comprises sending the new outbound agent request containing the application task results together with an agent request asking for additional one or more application tasks to be performed by the internal application on behalf of the external application.

3. The method of claim 1, further comprising, at the second agent process, recreating the one or more application tasks contained in the inbound agent reply, and re-issuing the one or more application tasks to the internal application.

4. The method of claim 3, further comprising, at the second agent process, receiving the application task results from the internal application.

5. The method of claim 1, further comprising, at the first agent process:
receiving the outbound agent request from the second agent process;
waiting for an application request from the external application for one or more application tasks to be performed by the internal application;
generating the inbound agent reply in response to receiving the application request from the external application; and
sending the inbound agent reply to the second agent process.

6. The method of claim 5, further comprising, at the first agent process:
receiving the new outbound agent request; and
presenting the application task results to the external application in an application reply that is correlated to the application request.

7. The method of claim 6, further comprising, at the first agent process, sending a new inbound agent reply to the second agent process when a new application request for one or more application tasks is received from the external application.

8. The method of claim 1, wherein the first agent process and second agent process send agent requests and agent replies to each other using Layer 5 communications, the first agent process communicates with the external application using Layer 7 communications and the second agent process communicates with the internal application using Layer 7 communications.

9. A system comprising:
a first computing environment including a first agent process in communication with a first application; and
a second computing environment including a second agent process in communication with a second application, both the second agent process and second application running behind a firewall;
the second agent process configured to:
send an outbound agent request across the firewall to the first agent process, the outbound agent request configured to ask for one or more application tasks to be performed by the second application;
receive an inbound agent reply from the first agent process sent in response to the outbound agent request, the inbound agent reply specifying one or more application tasks to be performed by the second application on behalf of the first application;
recreate the one or more application tasks contained in the inbound agent reply; and
re-issue the one or more application tasks to the second application.

10. The system of claim 9, wherein the second agent process is further configured to:
receive the one or more application task results from the second application; and
send across the firewall to the first agent process a new outbound agent request containing the one or more application task results generated by the second application.

11. The system of claim 10, wherein the second agent process is configured to send the new outbound agent request containing the one or more application task results together with an agent request asking for one or more additional application tasks to be performed by the second application on behalf of the first application.

12. The system of claim 9, wherein the first agent process is configured to:
receive the outbound agent request from the second agent process;
wait for an application request from the first application for one or more application tasks to be performed by the second application;
generate the inbound agent reply in response to receiving the application request from the first application; and
send the inbound agent reply to the second agent process.

13. The system of claim 12, wherein the first agent process is further configured to:
receive the new outbound agent request; and
present the application task results to the first application in an application reply that is correlated to the application request.

14. The system of claim 13, wherein the first agent process is further configured to:
send a new inbound agent reply to the second agent process when a new application request for one or more application tasks is received from the first application.

15. The system of claim 9, wherein the first agent process and second agent process are configured to send agent requests and agent replies to each other using Layer 5 communications, the first agent process communicates with the external application using Layer 7 communications and the second agent process communicates with the internal application using Layer 7 communications.

16. The system of claim 9, wherein the first computing environment and second computing environment are physical computing systems.

17. The system of claim 9, wherein one or both of the first and second computing environments are virtual computing environments running in a data center or cloud computing system.

18. An apparatus comprising:
a network interface device configured to enable communications over a network; and
a processor coupled to the network interface device, wherein the processor is configured to:
generate and send an outbound agent request across a firewall from a second agent process running behind the firewall in a computing environment to a first agent process outside of the computing environment, the outbound agent request asking for one or more application tasks to be performed by an internal application within the computing environment;
receive an inbound agent reply from the first agent process sent in response to the outbound agent request, the inbound agent reply specifying one or more application tasks to be performed by the internal application on behalf of an external application; and
recreate the one or more application tasks contained in the inbound agent reply, and re-issue the one or more application tasks to the internal application.

19. The apparatus of claim 18, wherein the processor is configured to:
receive the one or more application task results from the internal application; and
send across the firewall to the first agent process a new outbound agent request containing the one or more application task results generated by the internal application.

20. The apparatus of claim 19, wherein the processor is configured to send the new outbound agent request containing the one or more application task results together with an agent request asking for one or more additional application tasks to be performed by the internal application on behalf of the external application.

21. One or more computer readable storage media encoded with software comprising computer executable instructions and when the software is executed operable to:
generate and send an outbound agent request across a firewall from a second agent process running behind the firewall in a computing environment to a first agent process outside of the computing environment, the outbound agent request asking for one or more application tasks to be performed by an internal application within the computing environment;
receive an inbound agent reply from the first agent process sent in response to the outbound agent request, the inbound agent reply specifying one or more application tasks to be performed by the internal application on behalf of an external application;
recreate the one or more application tasks contained in the inbound agent reply; and
re-issue the one or more application tasks to the internal application.

22. The computer readable storage media of claim 21, further comprising instructions operable to:
receive the one or more application task results from the internal application; and
send across the firewall to the first agent process a new outbound agent request containing the one or more application task results generated by the internal application.

23. The computer readable storage media of claim 22, further comprising instructions operable to send the new outbound agent request containing the one or more application task results together with an agent request asking for one or more additional application tasks to be performed by the internal application on behalf of the external application.
